(19) United States
(12) Patent Application Publication
(10) Pub. No.: US 2023/0306260 A1
(43) Pub. Date: Sep. 28, 2023

(54) DETECTION METHOD, DETECTION APPARATUS, AND PROGRAM

(71) Applicant: NIPPON TELEGRAPH AND TELEPHONE CORPORATION, Tokyo (JP)

(72) Inventors: Ryotaro SATO, Tokyo (JP); Kenta NIWA, Tokyo (JP); Kazunori KOBAYASHI, Tokyo (JP)

(73) Assignee: NIPPON TELEGRAPH AND TELEPHONE CORPORATION, Tokyo (JP)

(21) Appl. No.: 18/022,112

(22) PCT Filed: Aug. 21, 2020
(86) PCT No.: PCT/JP2020/031674

§ 371 Date: Feb. 17, 2023

(51) Int. Cl. G06N 3/08; H04R 5/027; G06F 17/16

(52) U.S. Cl. CPC G06N 3/08; H04R 5/027; G06F 17/16; H04S 3/008

(57) ABSTRACT

There are provided a detection method, a detection device, and a program that do not cause a difference in events to be detected even when physical characteristics of an acoustic signal change. The detection method includes: a step of acquiring a target sound for detecting an event; and a detecting step of detecting a desired event included in the acquired sound, and in the detecting step, even when any one of a distance and a direction of a sound source of the event, which are based on a position where the target sound is collected, and an occurrence time of the event changes, the events are always detected as the same event.

### TECHNICAL FIELD

The present invention relates to a detection technology for detecting events from acoustic signals.

### BACKGROUND ART

Attempts to detect events from acoustic signals have been made for a long time. Examples include detecting abnormalities from environmental sounds. For example, in NPL 1, an autoencoder is used to determine an abnormality based on a reconstruction error.

### CITATION LIST

### Non Patent Literature

[NPL 1] Akinori Ito, “Special Edition—Recent Trends in Understanding the Sound Environment: Acoustic Event Analysis and Acoustic Scene Analysis—Statistical Methods for Detecting Abnormalities from Environmental Sounds,” 2019, Vol. 75, No. 9, p. 538-543

### SUMMARY OF INVENTION

### Technical Problem

However, the technology in the related art does not take into account the physical characteristics of the acoustic signal. For example, when the distance between the sound source and the microphone array changes, when the direction of the sound source based on the microphone array changes, or when the occurrence time of an event to be detected changes, an abnormality may or may not be determined based on the learning data.

An object of the present invention is to provide a detection method, a detection device, and a program that do not cause a difference in events to be detected even when physical characteristics of an acoustic signal change.

### Solution to Problem

In order to solve the above problem, according to an aspect of the present invention, a detection method includes: a step of acquiring a target sound for detecting an event; and a detecting step of detecting a desired event included in the acquired sound, and in the detecting step, even when any one of a distance and a direction of a sound source of the event, which are based on a position where the target sound is collected, and an occurrence time of the event changes, the events are always detected as the same event.

In order to solve the above problem, according to another aspect of the present invention, a detection method includes detecting a desired event included in an acoustic signal. In the detection method, a detection model includes a deep neural network, and the method includes: a bilinear operation step of obtaining Z^{i+1,f,t}_{L,j} by

$$[ Math . 1 ]$$

$${z}_{L , j}^{i + 1 , f , t} = {\sum }_{{L}_{1} , {L}_{2} : - \vert {L}_{1} - {L}_{2} \vert \leq L \leq {L}_{1} + {L}_{2}} {\sum }_{{j}_{1} = 1}^{{τ}_{i} , {L}_{1}} {\sum }_{{j}_{2} = 1}^{{τ}_{i} , {L}_{1}} {a}_{j , {j}_{1} , {j}_{2}}^{L , {L}_{1} , {L}_{2}} \frac{E}{\sqrt{‖ E ‖}}$$

$$and$$

$$[ Math . 2 ]$$

$$E = {C}^{L , {L}_{1} , {L}_{2}} ( {z}_{{L}_{1} , {j}_{1}}^{i , f , t} ⊗ {z}_{{L}_{2} , {j}_{2}}^{i , f , t} )$$

using an output value Z^{i,f,t}_{L,j} of a previous layer, while a^{L,L_1,L_2}_{j,j_1,j_2} is defined as a weight of a linear sum and C^{L,L_1,L_2} is defined as a constant matrix; and a time-frequency convolution step of performing time-frequency convolution to obtain Z^{i+1,f,t}_{L,j} by

$$[ Math . 3 ]$$

$${z}_{L , j}^{i + 1 , f , t} = {\sum }_{{f}^{′} = 1}^{{K}_{i}} {\sum }_{{t}^{′} = 1}^{{L}_{i}} {\sum }_{{j}^{′} = 1}^{{τ}_{i , L}} {a}_{L , j , {j}^{′}}^{i , {f}^{′} , {t}^{′}} , {z}_{L , {j}^{′}}^{i , f + {f}^{′} - 1 , t + {t}^{′} - 1}$$

using an output value Z^{i,f,t}_{L,j} of a previous layer, while a^{i,f,t}_{L,j,j}, is defined as a filter for each channel of complex variables.

### Advantageous Effects of Invention

According to the present invention, even when physical characteristics of the acoustic signal change, an effect that there is no difference in the event to be detected is achieved.

### BRIEF DESCRIPTION OF DRAWINGS

FIG. 1 shows an overall architecture of a model example constructed in a first embodiment.

FIG. 2 shows an overall architecture of a model example constructed in the first embodiment.

FIG. 3 is a functional block diagram of a detection device according to the first embodiment.

FIG. 4 is a diagram showing an example of a processing flow of the detection device according to the first embodiment.

FIG. 5 is a functional block diagram of a model learning device according to the first embodiment.

FIG. 6 is a diagram showing an example of a processing flow of the model learning device according to the first embodiment.

FIG. 7 is a diagram showing a result of an experiment using the detection device according to the first embodiment.

FIG. 8 is a diagram showing a configuration example of a computer to which the present method is applied.

### DESCRIPTION OF EMBODIMENTS

Hereinafter, an embodiment of the present invention will be described. In the diagrams used for the following description, the same reference numerals are given to constituents with the same functions or steps of performing the same processing, and repeated description thereof will be omitted. In the following descriptions, symbols “\hat{ }” or the like that will be used in text should be originally notated above the following character, but are notated right before the character due to limitations of the text. In Equations, these symbols will be placed at their original positions. Further, processing performed in units of respective elements such as vectors and matrices will be applied to all the elements of the vector or the matrices unless otherwise specifically noted.

<Overview of First Embodiment>

The first embodiment proposes a design method of a model that satisfies a specific relational expression (constraint condition) particularly based on physical assumptions between input and output, and an acoustic event detecting and sound source direction estimation DNN model based on the design method, in a DNN learning and inference model for performing processing by using an Ambisonics signal, which is a common format for stereophonic acoustic signals, as an input.

A multi-channel signal contains both physical information on a sound source position and acoustic information such as timbre. Of these, since physical information can be described as a pure physical phenomenon, a powerful algebraic property regarding the behavior of a signal with respect to a change in sound source position is known. In the present embodiment, by explicitly reflecting this knowledge in the model design, a new DNN technology that realizes parameter-saving and learning-saving data is provided.

The DNN-based approach is based on learning a DNN model with a large amount of data tagged with the type of acoustic event and the arrival direction thereof. However, in general, a DNN-based method requires a large amount of data for model learning, and particularly in acoustic event detecting and sound source direction estimation, sounds from multiple directions are required as learning data. This situation is considered a major obstacle to the introduction of technology into commercialization. In the present embodiment, the problem of reducing the amount of learning data is solved by reviewing the DNN from the design level in consideration of the physical properties of the multi-channel acoustic signal. When an acoustic event has been recorded as a multi-channel signal, the signal that would be able to be obtained had the acoustic event occurred at another location can be obtained by performing a simple transformation on the original signal under certain conditions. Although this property is known as physics and acoustic knowledge, such knowledge is not pre-embedded in the DNN model and can only be acquired and learned during data-driven learning. In the present embodiment, an acoustic signal processing DNN model is introduced in which physical knowledge is taught in advance by performing designing to guarantee that the DNN model always satisfies the property of equivariance for such physical transformation. By using this technology, even when the learning data contains only acoustic event data coming from a very limited range of directions, in actual use, a DNN model in which event detecting or direction estimation can be performed with the same accuracy for sounds coming from all directions becomes possible. As a result, model learning will be possible with a smaller amount of learning data than in the related art, and a wider range of practical use is expected to be possible.

First, the prerequisite knowledge will be described, and then the proposed method will be described. Further, a specific DNN model design is performed based on a proposed method. Then, the detection device according to the present embodiment will be described. Finally, an experimental evaluation of the detection device and the sound source direction estimation device according to the present embodiment is performed.

<Prerequisite Knowledge>

First, various definitions will be given for Ambisonics, which is a format of spatial acoustic signal dealt with in the first embodiment, and the behavior and properties when 3D rotation is applied to Ambisonics will be confirmed.

<Ambisonics>

In the present embodiment, Ambisonics, which is a general-purpose format for spatial acoustic signals, is introduced. The sound field propagating in a three-dimensional space is represented by the sound pressure distribution p(r, θ, φ) expressed in polar coordinates (r, θ, φ) (0≤r, 0≤θ≤π, 0≤φ<2π).

The following form is used as the spherical harmonic function Y^{m}_{L}(θ, φ) (L □{0, 1, . . . }, m□{−L, . . . , L}).

$$[ Math . 4 ]$$

$${Y}_{L}^{m} ( θ , ϕ ) = {( - 1 )}^{m} \sqrt{\frac{2 L + 1}{4 π} \frac{( L - \vert m \vert ) !}{( L + \vert m \vert ) !}} {P}_{L}^{\vert m \vert} ( cos θ ) {e}^{im ϕ}$$

Here, i expresses the imaginary unit and P^{m}_{L}(x) satisfies the associated Legendre polynomials, that is

$$[ Math . 5 ]$$

$${P}_{L}^{m} ( t ) = \frac{1}{{2}^{L}} {( 1 - {t}^{2} )}^{\frac{m}{2}} {\sum }_{j = 0}^{⌊ ( L - m ) / 2 ⌋} A$$

$$and$$

$$[ Math . 6 ]$$

$$A = \frac{{( - 1 )}^{j} ( 2 L - 2 j ) !}{j ! ( L - j ) ! ( L - 2 j - m ) !} {t}^{L - 2 j - m} \qquad ( 1 )$$

$$However ,$$

$$[ Math . 7 ]$$

$$⌊ X ⌋$$

expresses the floor function and expresses the maximum integer not exceeding x.

Regarding the sound field p(r, θ, φ, t) displayed in polar coordinates for space, attention is paid particularly to one spherical surface in which r is fixed to r₀. However, the radius r₀ corresponds to the radius of the circle or sphere formed by the microphones placed in the space. Ambisonics corresponds to expansion coefficients B^{m}_{L}(t) when the function p(r₀, θ, φ, t), which has only θ and φ as arguments, is expanded in sphere harmonization with Y^{m}_{L}(θ, φ) at each time t. However, when the Fourier transform is applied to time, the component of frequency f is expressed as p(r₀, θ, φ, f). The relationship between p(r₀, θ, φ, f) and B^{m}_{L}(f) is expressed by the following equation.

$$[ Math . 8 ]$$

$$p ( {r}_{0} , θ , ϕ , f ) = {\sum }_{L = 0}^{∞} {\sum }_{m = - L}^{L} {B}_{L}^{m} ( f ) {j}_{L} ( {kr}_{0} ) {Y}_{L}^{m} ( θ , ϕ ) \qquad ( 2 )$$

Here, j_{L}(x) represents the sphere Bessel function, and k represents the wave number of the sound field and is expressed by k=2πf/c using the frequency f and the sound speed c.

Ambisonics has several aspects depending on the number of channels, and first-order Ambisonics (FOA) is that having information on 4 channels (B⁰₀, B⁻¹₁, B⁰₁, B¹₁) up to L≤1. In the format called B-format, which is particularly widely used in FOA, 4 channels are named (W, X, Y, Z), and {B^{m}_{L}} has a correspondence of

$$[ Math . 9 ]$$

$$( \begin{matrix}W \\ X \\ Y \\ Z\end{matrix} ) = ( \begin{matrix}1 & 0 & 0 & 0 \\ 0 & \frac{1}{\sqrt{2}} & 0 & \frac{- 1}{\sqrt{2}} \\ 0 & \frac{i}{\sqrt{2}} & 0 & \frac{i}{\sqrt{2}} \\ 0 & 0 & 1 & 0\end{matrix} ) ( \begin{matrix}{B}_{0}^{0} \\ {B}_{1}^{- 1} \\ {B}_{1}^{0} \\ {B}_{1}^{1}\end{matrix} ) \qquad ( 3 )$$

Here, i is an imaginary unit. Hereinafter, the frequency f will be omitted as appropriate. In addition, a case where higher-order coefficients with L 2 are also included and the number of channels is more than 4 channels is called higher-order Ambisonics (HOA). There are various definitions for FOA and HOA formats, but since these can be transformed to each other by a simple linear transformation, those with the same number of channels have substantially equivalent information. Therefore, in the following, only the format defined as the expansion coefficient of Equation (2) will be described, but this description content is valid for all formats. Further, the technology of the embodiment can be applied to a general multi-channel acoustic signal not limited to the Ambisonics format by transforming the signal into the Ambisonics format by performing sphere harmonization expansion of the sound field. Here, the coefficient {H^{m}_{L}}:

$$[ Math . 10 ]$$

$$h ( θ , ϕ ) = {\sum }_{L = 0}^{∞} {\sum }_{m = - L}^{L} {H}_{L}^{m} \cdot {Y}_{L}^{m} ( θ , ϕ ) \qquad ( 4 )$$

obtained by performing sphere-harmonic expansion with respect to the function h(θ, φ), which generally has a value at each point on the sphere, not limited to p(r₀, θ, φ, f), is often a subject of consideration. For the sake of simplicity, the summary of the sphere harmonization expansion coefficients for the function h for each order L is notated as follows.

[Math. 11]

H_{L}:=[H_{L}^{-L}, . . . ,H_{L}^{L}]^{T}∈ [symbol] ^{2L+1} (5)

Here, ^{T} expresses the transpose of a vector or matrix. Furthermore, when this is arranged for all L, it can be notated as follows.

$$[ Math . 12 ]$$

$$H = {[ {H}_{0}^{T} , {H}_{1}^{T} , … ]}^{T} = {[ {H}_{0}^{0} , {H}_{1}^{- 1} , {H}_{1}^{0} , {H}_{1}^{1} , {H}_{2}^{- 2} , … ]}^{T} \qquad ( 6 )$$

<Rotation in Three-Dimensional Space>

Since the Ambisonics signal can be rotated in a three-dimensional space, the properties thereof will be confirmed. Ambisonics has a mathematical aspect of the sphere harmonization expansion coefficient of a function as seen in Equation (2). Therefore, even when the signal is recorded for the same phenomenon, the apparent value changes depending on how the spatial coordinate axis is taken. The relationship of the sound field p(x, y, z) observed in the three-dimensional coordinate system (x, y, z) and the sound field p′(x, y, z) with some rotational movement added to the entire sound field (with the origin fixed) will be considered. As rotation, moving the unit vectors eₓ, e_{y}, and e_{z} of each axis of the coordinate system to e′ₓ, e′_{y}, and e′_{z}, respectively, is considered. This movement can be described as

[Math. 13]

(e′ₓ,e′_{y},e′_{z})=(eₓ,e_{y},e_{z})R (7)

using a 3×3 matrix R satisfying RR^{T}=I and det R=1. The entire 3×3 matrix that satisfies RR^{T}=I and det R=1 is called SO(3). The coordinates r′=(x′, y′, z′)^{T} to which the position r=(x, y, z)^{T} is moved by the rotation R are expressed as r′=Rr from the condition of xe′ₓ+ye′_{y}+ze′_{z}=x′eₓ+y′e_{y}+z′e_{z}. Rotation in a three-dimensional space can be specifically expressed using three consecutive rotations centered on the z-axis, y-axis, and z-axis, and when all three parameters (Euler angles) that express the angle of rotation are set to (α, β, γ), R can be explicitly notated by a combination of these trigonometric functions.

The sphere harmonic expansion coefficient of a function on a sphere including Ambisonics can also give the rotation of the entire physical system by appropriate linear transformation. Regarding the Ambisonics signal B=[B^{T}₀, B^{T}₁, . . . ]^{T} recorded in a certain environment, the Ambisonics signal B(α, β, γ) that would have been obtained for a sound field rotated by R(α, β, γ) is considered from the original situation. It is known that this is given by the relational expression

[Math. 14]

B_{L}^{(α,β,γ)}=D^{L}(α,β,γ)B_{L}^{∀}L=0,1, . . . (8)

using a (2L+1)-dimensional complex matrix D^{L}(α, β, γ) that depends on α, β, and γ and the sphere harmonization expansion order L. Here, D^{L}(α, β, γ) is the Wigner D-matrix. The definition of the Wigner D-matrix will be described later. As a notation in the present embodiment, the block diagonal matrix D(α, β, γ) in which D^{L}(α, β, γ) are arranged is defined as

$$[ Math . 15 ]$$

$$D ( α , β , γ ) := ( \begin{matrix}{D}^{0} ( α , β , γ ) & 0 & 0 & … \\ 0 & {D}^{1} ( α , β , γ ) & 0 & \\ 0 & 0 & {D}^{2} ( α , β , γ ) & \\ ⋮ & & & ⋱\end{matrix} ) \qquad ( 9 )$$

As a result, the rotational transformation law of the sphere harmonization expansion coefficient of the Ambisonics signal or the like can be expressed by a single equation for all of L called

[Math. 16]

B^{(α,β,γ)}=D(α,β,γ)B (10)

<Proposed Method: DNN for Acoustic Signals Having Equivariance with Respect to Multiple Types of Transformation>

The present embodiment proposes a DNN model in which the inference result is not affected by changes in the apparent values of the Ambisonics signal, such as spatial rotation, scale transformation, and time translation. As an effect of this model, for example, it is possible to detect multi-channel events that do not depend on the direction of acoustic events, and to learn an omnidirectional sound source direction estimation model from acoustic event data in a limited direction. First, the equivariance, which is a property to be imposed on DNN, will be described. Next, a method of constructing an equivariant DNN model for each of rotation, scale transformation, and time translation will be described.

<Approach>

First, a transformation for performing spatial rotation, scale transformation, and time translation with respect to a variable of a sphere harmonization area including an Ambisonics signal, is introduced. In the present embodiment, the signal is basically dealt with in the time-frequency region subjected to the short-time Fourier transform, but here, for the description of the time translation, the signal in the time domain is dealt with. A transformation operation g=((α, β, γ), τ, λ) for performing scale transformation with respect to the Ambisonics signal x(t)=[x^{m}_{L}(t)]_{(L, m)}=[x⁰₀(t), x⁻¹₁(t), x⁰₁(t), x¹₁(t), . . . ]^{T} in the time domain, such that the entire signal is delayed by τ in the time domain, and the amplitude is multiplied by λ(>0) by a constant while performing rotation corresponding to the rotation matrix R(α, β, γ), is considered. The transformed signal (Φ_{g}x) can be notated as

[Math. 17]

(Φ_{g}x)(t)=λ·D(α,β,γ)x(t−τ) (11)

A set consisting of all possible transformation operations g as described above can be considered, and when this is called

[Math. 18]

G=((α,β,γ),τ,λ|(α,β,γ)∈SO(3),τ∈ [symbol] ,γ>0

this can be interpreted as a group. Inverse element g⁻¹=((−γ, −β, −α), −τ, 1/λ) exists in each transformation operation g□G, and the associative law holds for multiple transformation operations, and thus this includes a group structure. Particularly in this sense, Equation (11) is nothing but the left group action of G on the linear space formed by the entire input signal. The transformation by the elements included in this group changes the apparent numerical value of the signal, but the acoustic information captured by the signal before transformation is unchanged. In the present embodiment, an acoustic signal in the time-frequency domain, particularly a DNN model that deals with a signal subjected to a short-time Fourier transform as an input, is dealt with. The component X belonging to the frequency bin of frequency f in any time frame of the Ambisonics signal subjected to the short-time Fourier transform is considered. Applying the above-described transformation g=((α, β, γ), τ, λ) thereto is considered. However, the magnitude of the time translation T is sufficiently shorter than the window length of the short-time Fourier transform. At this time, the effect of time translation can be approximated as appearing almost exclusively as a change in the phase of the signal, and the transformed signal Φ_{g}X is expressed as

[Math. 19]

Φ_{g}X=λ·e^{2πifτ}·D(α,β,γ)X (12)

In constructing a DNN model that deals with Ambisonics signals, it is appropriate to impose a constraint on the model that the output should change accordingly for the above-described transformation to input data. For example, in the sound source direction estimation DNN, when the input signal is rotated 90 degrees clockwise, the constraint that the sound source direction vector output by the DNN should be rotated 90 degrees is imposed on the model. For the inference model y=h(x), when the transformation rule that the output should satisfy is ψ_{g}y when Φ_{g}x is given as the input signal obtained by applying the transformation g□G to x,

[Math. 20]

ψ_{g}h(x)=h(Φ_{g}x) (13)

satisfies any g and x. The above property (13) of the function h with respect to the group G is called G-equivariance, and research to incorporate this into machine learning is a hot topic. Although G-equivariance is a non-apparent and strong condition, G-equivariance is a valid request based on physical studies. By imposing appropriate constraints at the model design stage, when it is possible to guarantee that the equivariance between input and output is established, the redundancy of the number of learning parameters and features will be reduced, and efficient learning is expected to be possible.

The present embodiment deals particularly with a case where the input is an Ambisonics signal in the time-frequency domain. At this time, the range of the transformation g for which the equivariance is to be assumed and the design of the output transformation rule ψg for the input transformation are any range and design, and can be determined based on the physical knowledge obtained in advance for each task. For example, when the task is binary event detecting, there is a possibility that the sound volume level is effective for feature design, and thus the equivariance for scale transformation is not assumed, but it is necessary and sufficient to assume that the output is invariant for rotation to the input signal and time translation. Therefore, in this case, a subset (subgroup) H:={((α, β, γ), τ, λ)□G|λ=1} consisting of only those elements of G, particularly λ=1, is considered, and it would be appropriate to impose H-equivariance on h, assuming ψ_{g}(y)=y. On the other hand, when the task is sound source direction estimation, it is inferred that it is meaningful to impose the equivariance on the scale transformation because there is no relation between the sound volume level and the sound source direction. Therefore, in the case of sound source direction estimation, it is appropriate to impose the equivariance on G itself, not on a part of G.

One of the points of the present embodiment is to construct a DNN model in which the equivariance for “rotation” and the equivariance for “scale constant multiple” and “time translation” are imposed as constraint conditions. In the related art, there has already been a DNN that uses the sphere harmonization expansion coefficient of image data on a spherical surface as an input and imposes the equivariance on rotation, but in the present embodiment, attention is paid to the characteristics of data called an acoustic signal, and the equivariance is imposed on the other two transformations in addition to rotation. First, regarding the scale constant multiple, the sound volume (scale) of the acoustic signal changes depending on the distance from the microphone, but the information such as the sound source direction does not change accordingly. This is different from image data in which the value for each pixel has an upper limit and a lower limit, and indicates that it is necessary to newly impose the equivariance on the acoustic signal with respect to the scale constant multiple. Regarding time translation, there was no precedent for handling data that spread in the time direction with DNN that has the equivariance with respect to rotation. Since the signal in the time-frequency domain is greatly affected by the minute time translation, particularly for the phase component of the high frequency bin, it is important to properly control the output of the DNN by explicitly considering the equivariance for the time translation.

In the following, the minimum constraints that must be imposed on the model to give the DNN model the equivariance for various transformations of rotation, scale constant multiple, and time translation will be described.

<Nonlinear Operation that Keeps Equivariance with Respect to Three-Dimensional Rotation>

The DNN design method with the policy that all hidden layer variables and outputs inductively satisfy the equivariance, and the entire model satisfies the equivariance by adopting the one that satisfies the equivariance for all operations inside the DNN model, has already been proposed (refer to Reference 1), and the present embodiment also follows this policy.
(Reference 1) R. Kondor, Z. Lin, and S. Trivedi, “Clebsch-Gordan Nets: a fully fourier space spherical convolutional neural network,” in Advances in Neural Information Processing Systems 31, S. Bengio, H. Wallach, H. Larochelle, K. Grauman, N. Cesa-Bianchi, and R. Garnett, Eds. Curran Associates, Inc., 2018, pp. 10117-10126.

In other words, when the operations that satisfy the equivariance are listed and the DNN is configured using only the operations, the entire model naturally satisfies the equivariance. The present embodiment is the first attempt to apply this approach to acoustic signal processing.

The method of imposing the equivariance will be described. In this model, all variables of input and hidden layers are dealt with in the sphere harmonization area. Assuming an FF type model as a model, all (hidden) variables in each layer i of DNN are notated by a vector having a set of subscripts (L, j) of

$$[ Math . 21 ]$$

$${( {( {z}_{L , j}^{i} )}_{j = 1}^{{τ}_{i , L}} )}_{L = 0}^{{L}_{max}} \qquad ( 14 )$$

Here, L=0, 1, . . . , Lₘₐₓ expresses the sphere harmonization expansion order. Lₘₐₓ expresses the upper limit of the order dealt with by this model. In other words, each variable zⁱ_{L,j}=[zⁱ_{L,j-L}, . . . , zⁱ_{L,j,L}]^{T} is a (2L+1)-dimensional complex vector. In a normal N-dimensional vector, the subscripts of each element start at 1 and end at N similar to [v₁, . . . , v_{N}], but the spherical harmonization expansion coefficient vector dealt with in the present embodiment has m=−L, . . . L and −L beginning and ending L corresponding to the corresponding spherical harmonization subscripts running Y^{-L}_{L}, . . . , Y^{L}_{L}. Further, τ_{i,L} expresses the number of L-th order coefficient vectors among the features of the i-th layer, and j indicates the number among these. Therefore, the feature dimension of the i-th layer is Σ^{L_max}_{L=0}(2L+1)τ_{i,L} (refer to Reference 1).

In addition, the operation to obtain the j-th feature of the sphere harmonization expansion order L of the (i+1)th layer from the variables of the i-th layer is notated as zⁱ⁺¹_{L,j}=hⁱ_{L,j}((zⁱ_{L′,j′})_{L′,j′}). Then, the condition of rotation equivariance for this operation is that

$$[ Math . 22 ]$$

$${D}_{L} ( α , β , γ ) {h}_{L , j}^{i} ( {( {z}_{{L}^{′} , {j}^{′}}^{i} )}_{{L}^{′} , {j}^{′}} ) ) = {h}_{L , j}^{i} ( {( {D}_{{L}^{′}} ( α , β , γ ) {z}_{{L}^{′} , {j}^{′}}^{i} )}_{{L}^{′} , {j}^{′}} ) \qquad ( 15 )$$

is satisfied for any rotation R(α, β, γ) and the input feature amount. Conversely, when defining every operation of the DNN such that this is always satisfied, the rotation equivariance of the entire model is automatically maintained. As an operation that satisfies the condition (15), an apparent operation such as a linear sum of variables belonging to the same expansion order L or a mere normalization of a single vector can be considered. However, in order to improve the learning ability of DNN, it is desirable to be able to perform more non-apparent and rich nonlinear operations, particularly operations that interact between different expansion orders. In the present embodiment, a new L-th-order sphere harmonization expansion coefficient vector z_{L} is used in a bilinear form

[Math. 23]

Z_{L}:=C^{L,L}^{₁}^{,L}^{₂}(u_{L}_{₁}⊗v_{L}_{₂}) (16)

called Clebsch-Gordan decomposition of u_{L_1} and v_{L_2}, which are two sphere harmonization expansion coefficient vectors of L₁ and L₂, respectively. Here, A_B in a subscript or superscript represents A_{B}. Only the integer L satisfying −|L₁−L₂|≤L≤L₁+L₂ is allowed as L on the left side of Equation (16).

[Math. 24]

u_{L}_{₁}⊗v_{L}_{₂}

is a Kronecker product for obtaining a (2_{L}1+1) (2_{L}2+1)th dimensional vector from a (2_{L}1+1)th dimensional vector and a (2_{L}2+1)th dimensional vector.

[Math. 25]

C^{L,L}^{₁}^{,L}^{₂}∈ [symbol] ^{(2L+1)×(2}^{_{L}}^{+1)(2L}^{₂}⁺¹⁾

is a constant matrix in which all elements are determined only by mathematics, and each element contains a mathematically determined constant or zero called the Clebsch-Gordan coefficient. For the sake of simplicity of notation, the notation of Equation (16) is used in the present embodiment, but when z_{L}=[z^{-L}_{L}, . . . , z^{L}_{L}]^{T} obtained by Equation (16) is specifically written, regarding each m=−L, −L+1, . . . , L,

$$[ Math . 26 ]$$

$${z}_{L}^{m} := {\sum }_{{m}_{1} = - {L}_{1}}^{{L}_{1}} {\sum }_{{m}_{2} = - {L}_{2}}^{{L}_{2}} {B}_{1} {u}_{{L}_{1} , {m}_{1}} {v}_{{L}_{2} , {m}_{2}} \qquad ( 17 )$$

$${B}_{1} = 〈 {L}_{1} , {m}_{1} ; {L}_{2} , {m}_{2} \vert {L}_{1} , {L}_{2} ; L , m 〉$$

is satisfied.

However,

$$[ Math . 27 ]$$

$$〈 {L}_{1} , {m}_{1} ; {L}_{2} , {m}_{2} \vert {L}_{1} , {L}_{2} ; L , m 〉 = {δ}_{m , {m}_{1} + {m}_{2}}$$

$$[ Math . 28 ]$$

$$\times \sqrt{\frac{( 2 L + 1 ) {B}_{2} ( L - {L}_{1} + {L}_{2} ) ! * ( {L}_{1} + {L}_{2} - L ) !}{( {L}_{1} + {L}_{2} + L + 1 ) !}}$$

$$[ Math . 29 ]$$

$$\times \sqrt{{B}_{3} ( {L}_{1} + {m}_{1} ) ! ( {L}_{2} - {m}_{2} ) ! ( {L}_{2} + {m}_{2} ) !}$$

$$[ Math . 30 ]$$

$$\times {\sum }_{k} \frac{{( - 1 )}^{k} / k !}{{B}_{4} {B}_{5} ( L - {L}_{1} - {m}_{2} + k ) !}$$

$$[ Math . 31 ]$$

$${B}_{2} = ( L + {L}_{1} - {L}_{2} ) !$$

$$[ Math . 32 ]$$

$${B}_{3} ( L + m ) ! ( L - m ) ! ( {L}_{1} - {m}_{1} ) !$$

$$[ Math . 33 ]$$

$${B}_{4} ( {L}_{1} + {L}_{2} - L - k ) ! ( {L}_{1} - {m}_{1} - k ) !$$

$$and$$

$$[ Math . 34 ]$$

$${B}_{5} = ( {L}_{2} + {m}_{2} - k ) ! ( L - {L}_{2} + {m}_{1} - k ) !$$

are satisfied. Here, the sum for k is taken for all non-negative integers of which none of the factors in the factorial that appear 5 times in the denominator are negative. This was first introduced to DNN by Reference 1, and it is known that the equation

[Math. 35]

D_{L}(α,β,γ)z_{L}=C^{L,L}^{₁}^{,L}^{₂}((D_{L}_{₁}(α,β,γ)u_{L}_{₁})⊗(D_{L}_{₂}(α,β,γ)v_{L}_{₂})) (18)

is always established, which is simply the definition of rotation equivariance.

A phenomenon in which the vector of the (|L₁−L₂|)th, . . . , (L₁+L₂)th new sphere harmonization area is often obtained from the Kronecker product of two vectors (L₁ and L₂, respectively) in the sphere harmonization area, is often written abstractly as in

[Math. 36]

L₁⊗L₂=|L₁−L₂|⊗ . . . ⊗(L₁+L₂) (19)

When using this, for example, an aspect in which 0th,1st, and 2nd order (L=0, 1, 2) coefficient vectors can be obtained as output one by one from two 1st (L=1) vectors, and an aspect in which 0th,1st, 2nd, 3rd, and 4th order (L=0, 1, 2, 3, 4) coefficient vectors can be obtained as output one by one from two 2nd (L=2) vectors, are respectively written as

[Math. 37]

1⊗1=0⊕1⊕2,

and

[Math. 38]

2⊗2=0⊕1⊕2⊕3⊕4

From the above, the operation zⁱ⁺¹_{L,j}=hⁱ_{L,j}((zⁱ_{L′,j′})_{L′,j′}) based on the Clebsch-Gordan decomposition is written in the following form.

$$[ Math . 39 ]$$

$${z}_{L , j}^{i + 1} = {\sum }_{{L}_{1} , {L}_{2} : - \vert {L}_{1} - {L}_{2} \vert \leq L \leq {L}_{1} + {L}_{2}} {\sum }_{{j}_{1} = 1}^{{τ}_{i , {L}_{1}}} {\sum }_{{j}_{2} = 1}^{{τ}_{i , {L}_{2}}} D$$

$$[ Math . 40 ]$$

$$D = {a}_{j , {j}_{1} , {j}_{2}}^{L , {L}_{1} , {L}_{2}} {C}^{L , {L}_{1} , {L}_{2}} ( {z}_{{L}_{1 ,} {j}_{1}}^{i} ⊗ {z}_{{L}_{2 ,} {j}_{2}}^{i} ) \qquad ( 20 )$$

Among these, the only parameters that can be learned are a^{L,L_1,L_2}_{j,j_1,j_2}, which are the weights of the linear sum after the Clebsch-Gordan decomposition. Although a^{L,L_1,L_2}_{j,j_1,j_2}, may be real numbers or complex numbers, the numbers are real numbers in the present embodiment. Further, in a situation where the number of a^{L,L_1,L_2}_{j,j_1,j_2} that can be learned becomes extremely large, a constraint may be imposed such that some of these are always 0.

<Equivariance with Respect to Scale Transformation>

It is described that, in order to satisfy the equivariance for the scale transformation of the amplitude of the input signal, the DNN model and the operation of each layer of the model should be specifically designed. In order to guarantee the equivariance with respect to scale transformation while holding the equivariance with respect to rotation, the bilinear form (16) introduced in the previous section is modified. In Equation (16) of the Clebsch-Gordan decomposition, when a value multiplied by A is input together with the input variables (u_{L_1}, v_{L_2}), the output variable will be multiplied by λ² as shown in

[Math. 41]

C^{L,L}^{₁}^{,L}^{₂}(λu_{L}_{₁})⊗(λv_{L}_{₂}))=λ²C^{L,n,m}(u_{L}_{₁}≤v_{L}_{₂}) (21)

However, in order to satisfy the equivariance with respect to scale transformation, the output should be A times. Therefore, in the present embodiment, a mechanism is proposed in which the equivariance with respect to amplitude scale transformation is maintained while maintaining the equivariance with respect to rotation by adding appropriate pre-processing and post-processing to the input variables and output variables of this layer. There are a plurality of aspects to achieve this goal, but in the present embodiment, a method for correcting the change in norm immediately after Equation (16) of the Clebsch-Gordan decomposition, is proposed. Specifically, an operation that takes the L² norm and divides it by the value obtained by taking the square root, which is called post-processing

$$[ Math . 42 ]$$

$${z}_{L} ↦ \frac{{z}_{L}}{\sqrt{{‖ {z}_{L} ‖}_{2}}} \qquad \text{(22)}$$

is applied to the result z_{L} obtained by Equation (16). As a result, the numerator of Equation (22) is λ² times and the denominator is A times the input λ times, and thus the finally obtained value on the left side is λ times, and the equivariance with respect to scale transformation is certainly satisfied. From the above,

$$[ Math . 43 ]$$

$${z}_{L , j}^{i + 1} = {\sum }_{{L}_{1} , {L}_{2} : - \vert {L}_{1} - {L}_{2} \vert \leq L \leq {L}_{1} + {L}_{2}} {\sum }_{{j}_{1} = 1}^{{τ}_{i , {L}_{1}}} {\sum }_{{j}_{2} = 1}^{{τ}_{i , {L}_{2}}} {a}_{j , {j}_{1} , {j}_{2}}^{L , {L}_{1} , {L}_{2}} \frac{E}{\sqrt{{‖ E ‖}_{2}}} and$$

$$[ Math . 44 ]$$

$$E = {C}^{L , {L}_{1} , {L}_{2}} ( {z}_{{L}_{1} , {j}_{1}}^{i} ⊗ {z}_{{L}_{2} , {j}_{2}}^{i} ) \qquad \text{(23)}$$

can be configured as examples of nonlinear operations that satisfy the equivariance with respect to rotation and scale constant multiple.

Further, the method of maintaining the equivariance with respect to rotation and scale transformation is not unique. As another aspect, for example, as in

$$[ Math . 45 ]$$

$${z}_{L , j}^{i + 1} = {\sum }_{{L}_{1} , {L}_{2} : - \vert {L}_{1} - {L}_{2} \vert \leq L \leq {L}_{1} + {L}_{2}} {\sum }_{{j}_{1} = 1}^{{τ}_{i , {L}_{1}}} {\sum }_{{j}_{2} = 1}^{{τ}_{i , {L}_{2}}} {a}_{j , {j}_{1} , {j}_{2}}^{L , {L}_{1} , {L}_{2}} {C}^{L , {L}_{1} , {L}_{2}} F$$

$$and$$

$$[ Math . 46 ]$$

$$F = ( \frac{{z}_{{L}_{1} {j}_{1}}^{i}}{{\sqrt{‖ {z}_{{L}_{1} , {j}_{1}}^{i} ‖}}_{2}} ⊗ \frac{{z}_{{L}_{2} , {L}_{3}}^{i}}{{\sqrt{‖ {z}_{{L}_{2} , {j}_{2}}^{i} ‖}}_{2}} ) \qquad ( 24 )$$

a method of dividing each input variable by the square root of the norm before performing the Clebsch-Gordan decomposition can be considered.

<Equivariance with Respect to Time Translation (Particularly, Invariance)>

A method of satisfying the equivariance of an input signal with respect to a minute time translation will be described. This is also a problem specific to DNN that deals with signals in the time-frequency domain, which has not been considered in the literature of the related art. In the inference model that deals with time series signals, the estimation results is desired to be invariant with respect to signal deviations in the time direction that are sufficiently shorter than the frame length. In the present embodiment, a method for guaranteeing the equivariance even with respect to minute changes over time while maintaining the equivariance with respect to rotation or scale transformation is proposed. A certain time series signal x(t) and a signal x′ (t): =x(t−τ) that is translated by a minute time T in the time direction are compared with each other and considered. When T is sufficiently smaller than the frame length when performing the short-time Fourier transform, it can be approximated that the effect of this time translation appears only as a phase difference in expression of the time-frequency domain (refer to Equation (12)). Since the meaning of the signal is invariant due to this minute time translation, the output of DNN should be equivariant, particularly invariant (in Equation (13) for definition of the equivariance, particularly, ψ_{g} is an identity operator) with respect to the change of T.

However, when the signal in the time-frequency domain subjected to the short-time Fourier transform is used as it is as an input, Equation (16) of the above-described Clebsch-Gordan decomposition causes the same problem as that of the scale transformation. For example, when one of the vectors obtained by Clebsch-Gordan decomposition with respect to the input variables u^{f_1}_{L_1} and v^{f_2}_{L_2} belonging to the frequency bins f₁ and f₂ is defined as z, the output is phase-shifted with respect to the time shift e2πi(f_1)τuf_1 and e2πi(f_2)τvf_2 of the input variables in a different format from e^{2πi(f_1+f_2)τ}Z.

As one of the methods for avoiding the above problems, it is effective to first perform a process on the input feature amount so as to be invariant with respect to time translation. Among the Ambisonics signals with short-time Fourier transform input to the DNN model, regarding the Ambisonics signals (B^{f,t}₀, B^{f,t}₁, . . . , B^{f,t}_{N}) in the frequency f and time frame t,

$$[ Math . 47 ]$$

$${[ {B}_{0}^{f , {t}^{T}} , {B}_{1}^{f , {t}^{T}} , … , {B}_{N}^{f , {t}^{T}} ]}^{T} ↦ {\frac{{B}_{0 , 0}^{f , {t}^{*}}}{\vert {B}_{0 , 0}^{f , t} \vert} [ {B}_{0}^{f , {t}^{T}} , {B}_{1}^{f , {t}^{T}} , … , {B}_{N}^{f , {t}^{T}} ]}^{T} \qquad ( 25 )$$

in which all the elements are divided by the phase component of B_{0,0} in the same frequency and the same time frame is used as an input of DNN. This transformation does not adversely affect the equivariance with respect to rotation and scale transformation, and further, for minute time translations, the original phase change and the phase change due to the complex conjugate of B_{0,0} cancel each other out, and thus the result is invariant.

<Wigner D-Matrix>

The Wigner D-matrix described in the above-described <Rotation in three-dimensional space> will be described in more detail. Here, a matrix (Wigner D-matrix) that performs rotational transformation on the sphere harmonization expansion coefficient vector is given. As a rotation in a three-dimensional space, continuous rotation is performed by (α, β, γ) around the z-axis, y-axis, and z-axis. The (2L+1)th-dimensional transformation matrix DL(α, β, γ)=(D^{L}(α, β, γ))^{m′m} for the L-th order sphere harmonization expansion coefficient vector corresponding to this rotation is expressed in a format of

[Math. 48]

(D^{L}(α,β,γ)_{m′,m}=e^{-im′α}d_{m′,m}^{L}(β)e^{-mγ} (A1)

d^{L}(β) is called the Wigner small-d matrix, the general form is written as

$$[ Math . 49 ]$$

$${d}_{{m}^{′} , m}^{L} ( β ) = {J}_{1} {\sum }_{s} \frac{{J}_{2} {J}_{3} {J}_{4}}{{J}_{5} s ! {J}_{6} {J}_{7}} \qquad ( A2 )$$

$$[ Math . 50 ]$$

$${J}_{1} = \sqrt{( L + {m}^{′} ) ! ( L - {m}^{′} ) ! ( L + m ) ! ( L - m ) !}$$

$$[ Math . 51 ]$$

$${J}_{2} = {( - 1 )}^{{m}^{′} - m + s}$$

$$[ Math . 52 ]$$

$${J}_{3} = {( cos \frac{β}{2} )}^{2 L + m - {m}^{′} - 2 s}$$

$$[ Math . 53 ]$$

$${J}_{4} = {( sin \frac{β}{2} )}^{{m}^{′} - m + 2 s}$$

$$[ Math . 54 ]$$

$${J}_{5} = ( L + m - s ) !$$

$$[ Math . 55 ]$$

$${J}_{6} = ( {m}^{′} - m + s ) !$$

$$and$$

$$[ Math . 56 ]$$

$${J}_{7} = ( L - {m}^{′} - {s}^{′} )$$

and properties such as d^{L}_{m′,m}=(−1)^{m-m′}d^{L}_{m,m′}=d^{L}_{-m,-m′} are established. The concrete form in L≤1 is

$$\begin{matrix}[ Math . 57 ] & \\ {d}_{0 , 0}^{0} = 1 , & ( A3 )\end{matrix}$$

$$\begin{matrix}[ Math . 58 ] & \\ {d}_{1 , 1}^{1} = \frac{1 + cos β}{2} , {d}_{1 , 0}^{1} = - \frac{sin β}{\sqrt{2}} , and & ( A4 )\end{matrix}$$

$$\begin{matrix}[ Math . 59 ] & \\ {d}_{1 , - 1}^{1} = \frac{1 + cos β}{2} , {d}_{0 , 0}^{1} = cos β & ( A5 )\end{matrix}$$

and the like and it is required that other elements also utilize the above-described properties.

<Model Design>

The above-described DNN design policy is applied to the problem of acoustic event detecting and sound source direction estimation tasks. Following the RCNN model used as a baseline method in the acoustic event detecting and sound source report estimation tasks in the previous research, a model is configured in which the Ambisonics signal in the time-frequency domain subjected to the short-time Fourier transform is input, and the event detecting and direction estimation results are output end-to-end. First, the overall configuration of the model will be described, and then each component thereof will be described.

<Design of Entire Model>

In the related art, following the format of the DNN used in the same task in the related art, the input of the DNN is the Ambisonics signal X⁻: =(X^{f,t})_{f,t}=(X^{f,t}_{L,j})_{L,j,f,t} in the time-frequency domain. In the present embodiment, f=1, 2, . . . is a subscript indicating the frequency bin number, and t=1, 2, . . . is a subscript indicating the number of time frames, and these are not the frequency and time itself, that is, a physical quantity with dimensions of Hz and s. As the DNN model in which y=(y_{c,t})_{c,t}□[0,1]^{C×T}, which indicates the presence or absence of each C-type acoustic event in each time frame t=1, . . . , T, and the sound source direction E=(e_{c,t})_{c,t} with respect to the interval in which the acoustic event exists are estimated and output,

[Math. 60]

y=h_{SED}(\tilde{X}), (26)

and

[Math. 61]

E=h_{DOA}(\tilde{X}) (27)

are configured. It is assumed that the sound volume level of the input signal has significant information in event detecting. Considering the group H consisting of rotation and time translation transformations, h_{SED} should satisfy H-equivariance (particularly, invariance).

[Math. 62]

h_{SED}(\tilde{X})=h_{SED}(Φ_{g}\tilde{X}),∀g∈H. (28)

On the other hand, in the sound source direction estimation, it is appropriate to perform the estimation regardless of the sound volume level. Therefore, a group G in which scale transformation operation is further added to H is defined, and design is performed such that f_{DOA} satisfies G-equivariance.

[Math. 63]

ψ_{g}h_{DOA}(\tilde{X})=h_{DOA}(Φ_{g}\tilde{X})),∀_{g}∈G. (29)

However, the actions Φ_{g} and ψ_{g} of the transformation g=((α, β, γ), τ, λ) on the input signal and the DOA output are defined in

[Math. 64]

Φ_{g}\tilde{X}=(λe^{2πifτ}D(α,β,β)X^{f,t})_{f,t}(30)

and

[Math. 65]

ψ_{g}E=(R(α,β,γ)e_{C,t})_{C,t} (31)

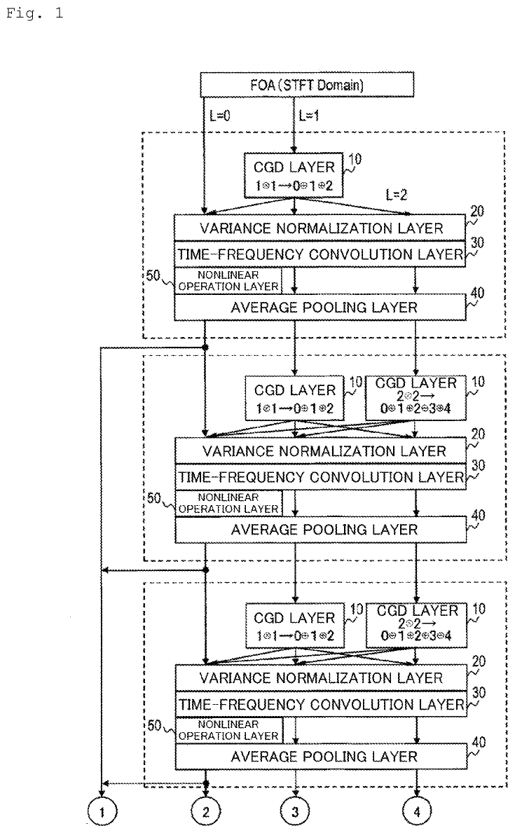

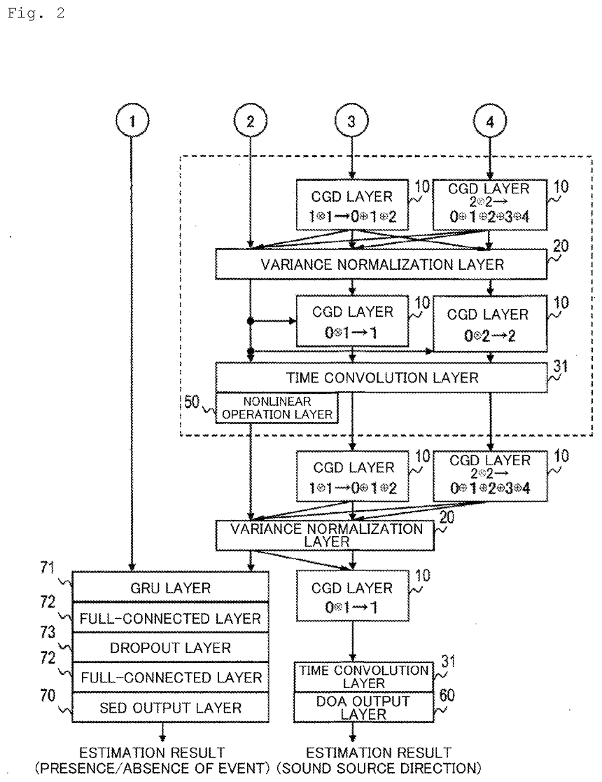

respectively. However, the contribution of the time translation T disappears by performing transformation of Equation (25) with respect to the input data in advance. FIGS. 1 and 2 show the overall architecture of the constructed model example. This is merely an example and does not necessarily have to be in this aspect in actual applications. Clebsch-Gordan decomposition and time-frequency convolution are essential processing, but other processing is not always necessary. Further, the essential processing does not necessarily have to be in the order and number as shown in FIG. 1. According to the notation introduced in Equation (14), the operation of each layer to obtain the variable of the (i+1)th layer from the variable of the i-th layer that constitutes this architecture is defined below.

<Clebsch-Gordan Decomposition (CGD) Layer 10>

In a Clebsch-Gordan decomposition (CGD) layer 10, the bilinear operation equation (20) is followed by the normalization Equation (22) for maintaining the equivariance with respect to the scale transformation. In other words, Equation (23) is performed. Since signals in the time-frequency domain is dealt with, the variables that have the subscript f in the frequency bin and the subscript t in the time frame are dealt with. Here, it is assumed that the operation is performed only for variables belonging to the same frequency bin and the same time frame.

$${z}_{L , j}^{i + 1 , f , t} = {\sum }_{{L}_{1} , {L}_{2} : - \vert {L}_{1} - {L}_{2} \vert \leq L \leq {L}_{1} + {L}_{2}} {\sum }_{{j}_{1} = 1}^{{τ}_{i} , {L}_{1}} {\sum }_{{j}_{2} = 1}^{{τ}_{i} , {L}_{2}} {a}_{j , {j}_{1} , {j}_{2}}^{L , {L}_{1} , {L}_{2}} \frac{E}{\sqrt{‖ E ‖}} \qquad [ Math . 66 ]$$

$$\begin{matrix}[ Math . 67 ] & \\ E = {C}^{L , {L}_{1} , {L}_{2}} ( {z}_{{L}_{1} , {j}_{1}}^{i , f , t} ⊗ {z}_{{L}_{2} , {j}_{2}}^{i , f , t} ) & ( 32 )\end{matrix}$$

In the present embodiment, in particular, the combination of the values of L₁ and L₂ of the two input vectors is also limited, and is shown in FIG. 1 using the notation of Equation (19). Moreover, only the sphere harmonization expansion coefficient in the range of L≤2 was dealt with. In the first layer, the output Z^{i+1,f,t}_{L,j} is calculated using the Ambisonics signal X^{f,t}_{L,j} instead of the output Z^{i,f,t}_{L,j} of the previous layer.

<Time-Frequency Convolution Layer 30 and Time Convolution Layer>

In the time-frequency convolution layer 30, convolution processing is performed in the time (and frequency) direction. Since each element of the sphere harmonization vector belongs to the complex domain, various operations are performed in the complex domain. The filter for each channel of the complex variable is described as

[Math. 68]

(a_{L,j,j′}^{i,f,t})_{f,t}∈ [symbol] ^{K}^{ᵢ}^{×L}^{ᵢ}

In other words, the filter size is Kᵢ in the frequency direction and Lᵢ in the time direction. The operation performed in the time-frequency convolution layer is expressed as

$$\begin{matrix}[ Math . 69 ] & \\ {z}_{L , j}^{i + 1 , f , t} = {\sum }_{{f}^{′} = 1}^{{K}_{i}} {{\sum }_{{t}^{′} = 1}}^{{L}_{i}} {\sum }_{{j}^{′} = 1}^{{τ}_{i} , L} {a}_{L , j , {j}^{′}}^{i , {f}^{′} , {t}^{′}} {z}_{L , {j}^{′}}^{i , f + {f}^{′} - 1 , t + {t}^{′} - 1} & ( 33 )\end{matrix}$$

In particular, when Kᵢ=1, since there is no convolution in the frequency direction, this case is called time convolution, and the time-frequency convolution layer 30 is called a time convolution layer. Here, in order to maintain the equivariance with respect to rotation, the bias term used in normal convolution is not adopted. Normal zero padding is performed in the boundary area of the subscripts f and t.

<Variance Normalization Layer 20>

A variance normalization layer 20 is introduced to stabilize learning. Batch normalization or the like is famous as normalization for learning stabilization and accuracy improvement, but when this is applied simply to the present method, the equivariance with respect to rotation and scale transformation is not satisfied. In the variance normalization proposed in the present embodiment, normalization is performed by the following equation using the statistical second moment (σ^{i,f}_{L,j})²=Eₜ[∥z^{i,f,t}_{L,j}∥²₂] of the L₂ norm with respect to i-th layer, f-th frequency bin, sphere harmonization expansion order L, and j-th feature vector z^{i,f,t}_{L,j}.

[Math. 70]

z_{L,j}^{i+1,f,t}=z_{L,j}^{i,f,t}/\sqrt{(σ_{L,j}^{i,f})²}. (34)

Accordingly, the expected value of the “square of L2 norm” of the variables z^{i+1,f,t}_{L,j} in the (i+1)th layer is normalized. The value of (σ^{i,f}_{L,j})² is sequentially updated by the moving average at the time of learning according to the following equation.

$$\begin{matrix}[ Math . 71 ] & \\ {( {σ}_{L , j}^{i , f} )}^{2} ← ( 1 - μ ) {( {σ}_{L , j}^{i , f} )}^{2} + μ \frac{1}{T} {\sum }_{t = 1}^{T} {‖ {z}_{L , j}^{i , f , t} ‖}_{2}^{2} & ( 35 )\end{matrix}$$

Here, μ is a predetermined parameter that determines the behavior of the moving average.

<Nonlinear Operation Layer 50: Other Operations for Variables with L=0>

In order to improve the expressiveness of the model, a nonlinear operation layer 50 that satisfies the equivariance with respect to rotation and scale transformation is introduced. Since the component of L=0 among the variables in the sphere harmonization region is invariant to rotation in the first place, the conditions of the equivariance are relaxed, and a wider class of operations can be applied. In the present embodiment, concatenated rectified linear unit (CReLU) is used as one of the nonlinear functions.

[Math. 72]

[symbol]

ReLU(z)=ReLU( [symbol] (z))+i·ReLU(ℑ(z)) (36)

However, in

[Math. 73]

[symbol]

(z),ℑ(z)

only the real part and the imaginary part are taken out for each element of the complex number (vector) z and arranged in the same shape as the original. When applied to the DNN notation of the present embodiment,

[Math. 74]

z_{0,j}^{i+1,f,t}

and

[Math. 75]

=ReLU( [symbol] (z_{0,j}^{i,f,t}))+i·ReLU(ℑ(z_{0,j}^{i,f,t})) (37)

are satisfied. Further, in the present embodiment, in a GRU layer 71, a full-connected layer 72, and a dropout layer 73, the operations used in the normal DNN such as gated recurrent unit (GRU), full connected (FC), and Dropout are used for the variable of L₀. These are applied after separating the input complex number into two real numbers (a real part and an imaginary part), and doubling the number of parameters. Some of these operations do not necessarily satisfy the equivariance with respect to scale transformation, but the result of this layer does not affect the result of sound source direction estimation for which the equivariance of scale transformation is desired to be imposed, rather, the operation is related to the result of event detecting for which the equivariance of the scale transformation is not desired to be imposed, and thus there is no problem.

<Average Pooling Layer 40>

In ordinary RCNN that deals with acoustic signals in the time-frequency domain, max-pooling is mainly used to reduce the feature dimension in the frequency direction. However, max-pooling does not satisfy the equivariance with respect to various transformations, and thus max-pooling needs to be replaced by another operation. By the operation of obtaining variables {z^{i+1,f,t}_{L,j}}_{f=1, . . . , f-(K/W)} of the (i+1)th layer in which the degree of freedom in the frequency direction is reduced to 1/W from the variables {z^{i+1,f,t}_{L,j}}_{f=1, . . . , K} of the (i+1)th layer having a structure in the frequency direction, in the present embodiment, average pooling is used as one of the operations that satisfy the equivariance with respect to rotation and scale transformation.

$$\begin{matrix}[ Math . 76 ] & \\ {z}_{L , j}^{1 + 1 , Wf , t} = \frac{1}{W} {\sum }_{{f}^{′} = W ( f - 1 ) + 1 , … , Wf} {z}_{L , j}^{i , {f}^{′} , t} & ( 38 )\end{matrix}$$

<DOA Output Layer 60>

In a DOA output layer 60, a variable in the form of an expansion coefficient vector in the sphere harmonization area is finally transformed into a three-dimensional real vector indicating the sound source direction. In this model, the sphere harmonization vector

[Math. 77]

z₁=[z₁⁻¹,z₁⁰,z₁¹]^{T}∈ [symbol] ²

belonging to L=1 is transformed into the three-dimensional real vector u=[uₓ, u_{y}, u_{z}]^{T} pointing in the direction of the sound source as follows.

$$\begin{matrix}[ Math . 78 ] & \\ ( \begin{matrix}{u}_{x} \\ {u}_{y} \\ {u}_{z}\end{matrix} ) = ( \begin{matrix}( {z}_{1}^{- 1} - {z}_{1}^{1} ) / \sqrt{2} \\ 𝒥 ( - {z}_{1}^{- 1} - {z}_{1}^{1} ) / \sqrt{2} \\ ( {z}_{1}^{0} )\end{matrix} ) . & ( 39 )\end{matrix}$$

Furthermore, the standardized e=u/∥u∥ is used as the estimation result. The e obtained by this operation has an intuitive meaning that the real part of the function Σ^{L}ₘ₌₋ᵢz^{m}₁Y^{m}₁ (θ, φ) takes the maximum value, and keeps the rotation equivariance which is R(α, β, γ)e=D¹ (α, β, γ)z₁. As shown in FIG. 2, the sphere harmonization vector z₁ belonging to L=1 is subjected to bilinear operation and normalization in the bilinear operation layer 10 from the vector of L=0 and the vector of L=1, the sphere harmonization vector z₁ can be obtained by further convolution in the time direction.

<SED Output Layer 70>

In order to obtain the estimation result of event detecting of C class, the processing of transforming the variable of L=0 is performed in the final layer. As described above, the variable of L=0 is invariant in the rotational transformation operation, and thus every operation satisfies the equivariance with respect to rotation. Following the known baseline method, the variable of L=0 is processed using GRU, full-connected layer, and dropout, and finally the presence or absence of acoustic events in the range of [0,1] through the activation function by sigmoid. GRU, FC, and dropout are performed in the GRU layer 71, the fully connected layer 72, and the dropout layer 73, respectively.

### First Embodiment

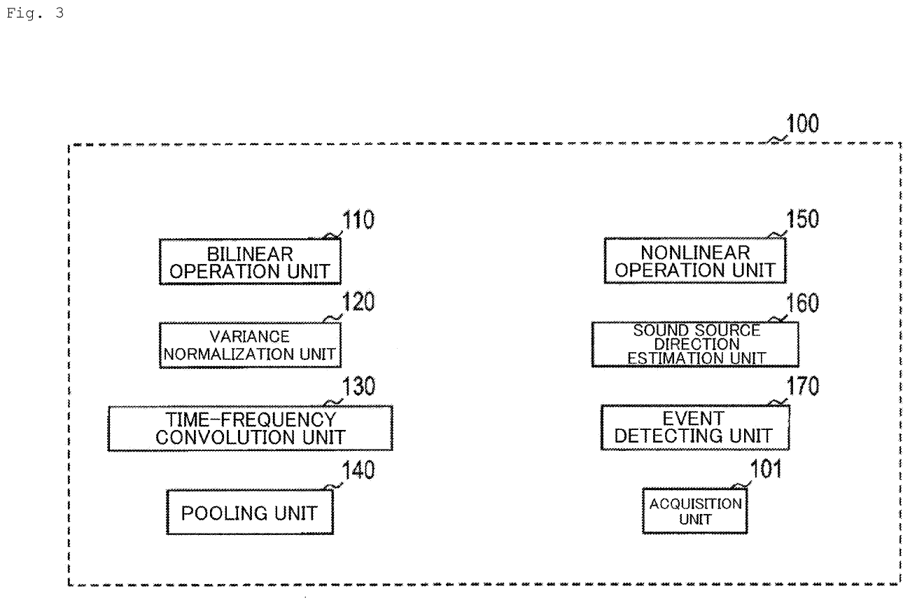

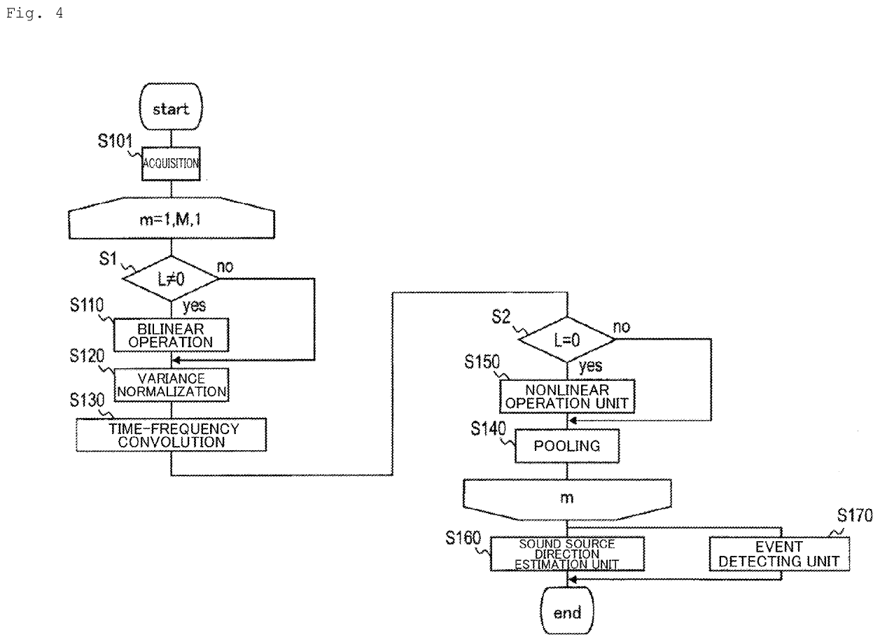

FIG. 3 is a functional block diagram of a detection device 100 according to the first embodiment, and FIG. 4 shows a processing flow thereof.

The detection device 100 includes an acquisition unit 101, a bilinear operation unit 110, a time-frequency convolution unit 130, a variance normalization unit 120, a pooling unit 140, a nonlinear operation unit 150, a sound source direction estimation unit 160, and an event detection unit 170.

The detection device 100 receives the Ambisonics signal ˜X in the time-frequency domain as inputs, detects the acoustic event included in the Ambisonics signal, estimates the sound source direction, and outputs the estimated sound source direction E as information y indicating the presence or absence of the acoustic event.

The detection device is a special device configured by loading a special program into a publicly known or dedicated computer having, for example, a central processing unit (CPU), a random access memory (RAM), and the like. The detection device executes each processing under the control of the CPU, for example. Data input to the detection device or data obtained in all processing is stored in, for example, the RAM, and the data stored in the RAM is read to the CPU to be used for other processing as necessary. At least a part of each processing unit of the detection device may be configured using hardware such as an integrated circuit. Each storage unit included in the detection device can be configured by, for example, a main storage device such as a random access memory (RAM) or middleware such as a relational database or a key value store. Here, each storage unit is not necessarily equipped inside the detection device, and may be configured by an auxiliary storage unit configured by a semiconductor memory element such as a hard disk, an optical disc, or a flash memory, and may be equipped outside of the detection device.

Hereinafter, the respective units will be described.

<Acquisition Unit 101>

The acquisition unit 101 acquires the sound of the target for which the event is detected, and outputs the sound (S101). In the present embodiment, the acquisition unit 101 acquires the Ambisonics signal ˜X in the time-frequency domain as the target sound. However, the acquisition unit 101 may acquire the Ambisonics signal ˜X in the time-frequency domain by inputting a general multi-channel acoustic signal and transforming the input signal into an Ambisonics format by performing sphere harmonization expansion of the sound field.

<Bilinear Operation Unit 110>

The following processing is performed on the variables other than L=0 among the variables in the sphere harmonization region (S1).

The bilinear operation unit 110 corresponds to the CGD layer 10 in FIG. 1, receives the output values Z^{i,f,t}_{L,j} of the previous layer as inputs, performs bilinear arithmetic and normalization (S110), and outputs Z^{i+1,f,t}_{L,j}. For example, the following bilinear operations and normalization are performed.

$${z}_{L , j}^{i + 1 , f , t} = {\sum }_{{L}_{1} , {L}_{2} : - \vert {L}_{1} - {L}_{2} \vert \leq L \leq {L}_{1} + {L}_{2}} {\sum }_{{j}_{1} = 1}^{{τ}_{i} , {L}_{1}} {\sum }_{{j}_{2} = 1}^{{τ}_{i} , {L}_{2}} {a}_{j , {j}_{1} , {j}_{2}}^{L , {L}_{1} , {L}_{2}} \frac{E}{\sqrt{‖ E ‖}} \qquad [ Math . 79 ]$$

$$\begin{matrix}[ Math . 80 ] & \\ E = {C}^{L , {L}_{1} , {L}_{2}} ( {z}_{{L}_{1} , {j}_{1}}^{i , f , t} ⊗ {z}_{{L}_{2} , {j}_{2}}^{i , f , t} ) & ( 32 )\end{matrix}$$

In the first layer, the output Z^{i+1,f,t}_{L,j} is calculated using the Ambisonics signals X^{f,t}_{L,j} instead of the output Z^{i,f,t}_{L,j} of the previous layer. Further, the bilinear operation unit 110 may perform the bilinear operation and normalization by using another method, for example, Equation (24).

<Variance Normalization Unit 120>

The variance normalization unit 120, corresponds to the variance normalization layer 20 shown in FIG. 1, receives the output values Z^{i,f,T}_{Lj} of the previous layer as inputs, performs variance normalization (S120), and outputs Z^{i+1,f,t}_{L,j}. For example, the following variance normalization is performed.

[Math. 81]

z_{L,j}^{i+1,f,t}=z_{L,j}^{i,f,t}/\sqrt{(σ_{L,j}^{i,f})²}. (34)

However, (σ^{i,f}_{L,j})² is the statistical second moment (σ^{i,f}_{L,j})²=Eₜ[∥z^{i,f,t}_{L,j}∥²₂] of L2 norm with respect to the j-th feature vector z^{i,f,t}_{L,j} by i-th layer, f-th frequency bin, and the sphere harmonization expansion order L.

<Time-Frequency Convolution Unit 130>

Corresponding to the time-frequency convolution unit 130 and the time-frequency convolution layer 30 in FIG. 1, the output value Z^{i,f,t}_{L,j} of the previous layer is used as an input to perform time-frequency convolution (S130), and Z^{i+1,f,t}_{L,j} is output. For example, the following time-frequency convolution is performed.

$$\begin{matrix}[ Math . 82 ] & \\ {z}_{L , j}^{i + 1 , f , t} = {\sum }_{{f}^{′} = 1}^{{K}_{i}} {{\sum }_{{t}^{′} = 1}}^{{L}_{i}} {\sum }_{{j}^{′} = 1}^{{τ}_{i} , L} {a}_{L , j , {j}^{′}}^{i , {f}^{′} , {t}^{′}} {z}_{L , {j}^{′}}^{i , f + {f}^{′} - 1 , t + {t}^{′} - 1} & ( 33 )\end{matrix}$$

However, a^{i,f,t}_{L,j,j′} is a filter for each channel of the complex variable.

<Nonlinear Operation Unit 150>

The following processing is performed on the component of L=0 among the variables in the sphere harmonization area (S2).

The nonlinear operation unit 150 corresponds to the nonlinear operation layer 50 in FIG. 1, uses the output value Z^{i,f,t}_{0,j} of the previous layer to perform a nonlinear operation (S150) as inputs, performs a nonlinear operation, and outputs Z^{i+1,f,t}_{0,j}. For example, a nonlinear operation is performed using the following CReLU.

[Math. 83]

z_{0,j}^{i+1,f,t}.

[Math. 84]

=ReLU( [symbol] (z_{0,j}^{i,f,t}))+i·ReLU(ℑ(z_{0,j}^{i,f,t})) (37)

However,

[Math. 85]

[symbol]

(z),ℑ(z)

is obtained by extracting only the real part and the imaginary part for each element of the complex number (vector) z and arranging these in the same shape as the original.

<Pooling Unit 140>

The pooling unit 140 corresponds to the average pooling layer 40 in FIG. 1, and inputs the output values Z^{i,f,t}_{L,j} of the previous layer to reduce the feature dimension in the frequency direction (S140), and outputs Z^{i+1,f,t}_{L,j}. For example, the following average pooling is used to reduce the feature dimension in the frequency direction.

$$\begin{matrix}[ Math . 86 ] & \\ {z}_{L , j}^{1 + 1 , Wf , t} = \frac{1}{W} {\sum }_{{f}^{′} = W ( f - 1 ) + 1 , … , Wf} {z}_{L , j}^{i , {f}^{′} , t} & ( 38 )\end{matrix}$$

The above-described processing S110, S120, S130, S150, and S140 are repeated M times. M is any integer of 1 or more. When the feature dimension in the frequency direction is sufficiently reduced in the pooling unit 140, only the time-frequency convolution may be performed in the time-frequency convolution unit 130.

<Sound Source Direction Estimation Unit 160>

The sound source direction estimation unit 160 corresponds to the DOA output layer 60 in FIG. 1, takes the output value

[Math. 87]

z₁=[z₁⁻¹,z₁⁰z₁¹]^{T}∈ [symbol] ³

of the previous layer as an input, transforms the value as follows, obtains e=u/∥u∥ in which u is standardized in

$$\begin{matrix}[ Math . 88 ] & \\ ( \begin{matrix}{u}_{x} \\ {u}_{y} \\ {u}_{z}\end{matrix} ) = ( \begin{matrix}( {z}_{1}^{- 1} - {z}_{1}^{1} ) / \sqrt{2} \\ 𝒥 ( - {z}_{1}^{- 1} - {z}_{1}^{1} ) / \sqrt{2} \\ ( {z}_{1}^{0} )\end{matrix} ) . & ( 39 )\end{matrix}$$

(S160), and outputs the estimation result E=(e_{c,t})_{c,t}.

<Event Detection Unit 170>

The event detection unit 170 corresponds to the SED output layer 70 of FIG. 1, detects a desired event included in the sound acquired by the acquisition unit 101 (S170), and outputs the detection result. For example, using the variable of L=0, which is the output value of the previous layer, as an input, the presence or absence of acoustic events is estimated in the range of [0,1] through the activation function by sigmoid, and the estimation result y=(y_{c,t})_{c,t}□[0,1]^{C×T} is output. As pre-processing, GRU, FC, and dropout may be performed.

In the present embodiment, since the model is designed according to the above-described model design, constraints on the rotational symmetry with respect to the acquired sound are imposed, and even when any one of the distance and direction of the sound source of the event and the occurrence time of the event changes based on the position where the sound of the target is collected, it is always detected that the event is the same.

Although it may be learned to have rotational symmetry in the related art, it depends on the learning data and the cost function, whereas the present embodiment always has rotational symmetry regardless of the learning data and the cost function.

Next, a method of learning the parameters used in the detection device 100 will be described.

<Model Learning Device 200>

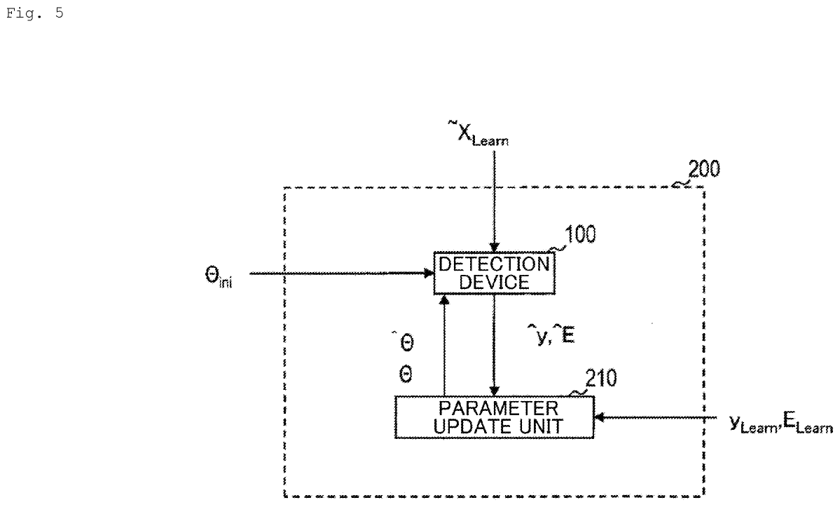

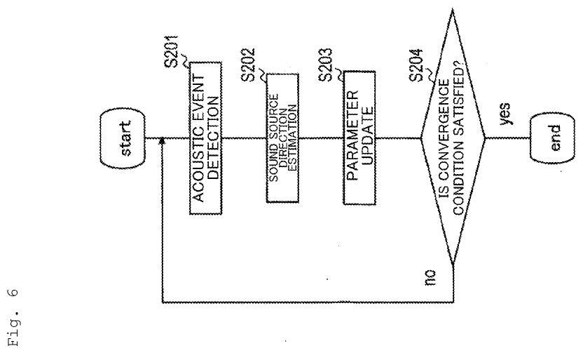

FIG. 5 shows a functional block diagram of a model learning device 200 according to the first embodiment, and FIG. 6 shows the processing flow thereof.

The model learning device 200 includes the detection device 100 and a parameter update unit 210.

The model learning device 200 inputs the Ambisonics signal ˜X_{Learn} in the time-frequency domain for learning, the correct data y_{Learn} indicating the presence or absence of an acoustic event included in the Ambisonics signal, and the correct data E_{Learn} indicating the sound source direction, learns a parameter \hat{ }Θ to be used in the detection device 100, and outputs the learned parameter Θ.

The parameter \hat{ }Θ includes a linear sum weight a^{L,L_1,L_2}_{j,j_1,j_2} used in the bilinear operation unit 110, a filter a^{i,f,t}_{L,j,j′} for each channel of the complex variable used in the time-frequency convolution unit 130, and the second moment (σ^{i,f}_{L,j})² used in the variance normalization unit 120. Furthermore, when the event detection unit 170 performs processing such as GRU, FC, dropout, and the like, the parameter \hat{ }Θ may include the parameter used at this time.

The model learning device 200 receives the initial value Θᵢₙᵢ of the parameter Θ or the parameter \hat{ }Θ updated by the parameter update unit 210. Furthermore, the model learning device 200 receives the Ambisonics signal ˜X_{Learn} in the time-frequency domain for learning as an input, detects an acoustic event included in the Ambisonics signal (S201), estimates the sound source direction thereof (S202), and outputs the sound source direction \hat{ }E estimated as the information \hat{ }y indicating the presence or absence of the acoustic event.

The parameter update unit 210 receives the information \hat{ }y, the sound source direction \hat{ }E, and the correct data y_{Learn} and E_{Learn} corresponding to the Ambisonics signal ˜X_{Learn} as inputs. The parameter update unit 210 updates the parameter \hat{ }Θ such that the difference between the information \hat{ }y and the correct data y_{Learn} and the difference between the sound source direction \hat{ }E and the correct data E_{Learn} are small (S203), and outputs the updated parameter \hat{ }Θ.

The model learning device 200 repeats the processing S201 to S203 until a predetermined convergence condition is satisfied (no in S204). When a predetermined convergence condition is satisfied (yes in S204), the model learning device 200 determines that learning has been completed, and outputs the learned parameter Θ to the detection device 100. As the convergence condition, it can be used whether the parameter \hat{ }Θ is updated a predetermined number of times, whether the difference between the parameters \hat{ }Θ before and after the update is equal to or less than a predetermined threshold value, and the like.

### Experimental Evaluation

### Experimental Conditions

In order to verify the validity of the proposed model, numerical simulations were performed to evaluate the learning and inference of the acoustic event detecting and sound source direction estimation model using an open data set. The task to be performed this time is to detect the presence or absence of each of the 11 types of acoustic events from the Ambisonics signal that simulates daily sound in the room, and to estimate the direction of each event when each event occurs. The data used was 400 1-minute FOA signals sampled at 48 kHz included in the TAU Spatial Sound Events 2019—Ambisonic dataset, of which 200 were training data, 100 were validation data, and 100 were testing data. The estimation result outputs the presence and absence of each acoustic event and the direction thereof for each frame.

In particular, in order to confirm the validity of the rotation equivariance of the proposed method, the existing data set processed was used as the learning data. The acoustic events included in the original learning data are evenly distributed over all azimuth angles. In the present embodiment, the rotation according to Equation (8) is added to the learning data in advance such that the number of acoustic events included in the learning data that are included in 0≤φ≤180° with respect to the azimuth angle φ is maximized. In particular, it is intended that there will be a difference in performance between the model of the related art and the proposed model regarding the direction estimation accuracy in the direction where the number of learning data is small. For the loss function, in both the method of the related art and the proposed method, binary cross-entropy is used for the acoustic event detecting result and the size of the central angle of the correct direction vector and the estimation vector is used for the direction estimation. In other words, regarding the estimation results (26) and (27) and the correct label (\hat{ }y_{c,t})_{c,t}, and (\hat{ }e_{c,t})_{c,t} related to the presence and absence and the direction thereof in each time frame t of c=1, . . . , 11 types of acoustic events,

$$\begin{matrix}[ Math . 89 ] & \\ L = {L}_{SED} + λ {L}_{DOA} , & ( 40 )\end{matrix}$$

$${L}_{SED} = {\sum }_{t = 1}^{T} {\sum }_{c = 1}^{11} [ - {\hat{y}}_{c , t} log {y}_{c , t} - ( 1 - {\hat{y}}_{c , t} ) log ( 1 - {y}_{c , t} ) ] and \qquad [ Math . 90 ]$$

$${L}_{DOA} = {\sum }_{t = 1}^{T} {\sum }_{{\hat{y}}_{c , t} = 1} arc cos ( {e}_{c , t} , {\hat{e}}_{c , t} ) \qquad [ Math . 91 ]$$

are loss functions. Here, λ is a parameter that determines the relative weights of SED and DOA, and in this experiment, λ=1. In SED, F-score and error rate (ER) were used as evaluation indexes. In DOA, the SED result was ignored, only the estimation result of the sound source direction was used, and the DOA error is evaluated by the average value of the angle arccos (e_{c,t}·\hat{ }e_{c,t}) formed by the direction vector of the correct label.

<Result of Experiment>

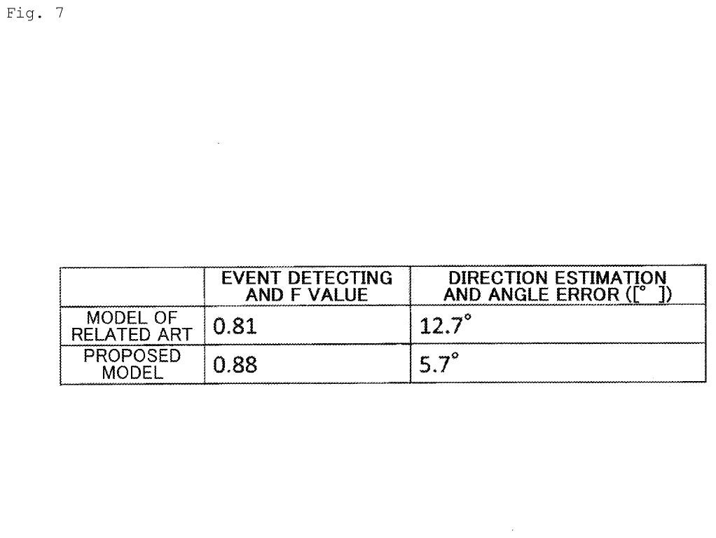

FIG. 7 shows the results of learning and estimation using the existing model and the proposed model under the above experimental conditions. As this result shows, it can be confirmed that the model of the proposed method can detect acoustic events and estimate the direction with high accuracy even when the sound source direction of the learning data is statistically biased compared to the DNN model of the related art.

<Effects>

In the present embodiment, attention was paid to the physical properties of multi-channel acoustic signals, and the DNN model design method in which this knowledge was acquired in advance in the form of DNN structure and constraints was proposed. It has been experimentally confirmed that the DNN acoustic event detecting and direction estimation model designed based on this theory can make an appropriate estimation even in a situation where the learning data is biased.

Even when physical characteristics of the acoustic signal change, the detection device according to the first embodiment has an effect that there is no difference in the detected event.

<Other Modification Examples>

The present invention is not limited to the foregoing embodiments and modification examples. For example, the above-described various kinds of processing may be performed chronologically, as described above, and may also be performed in parallel or individually in accordance with a processing capability of a device performing the processing or as necessary. In addition, changes can be made appropriately within the scope of the present invention without departing from the gist of the present invention.

<Program and Recording Medium>

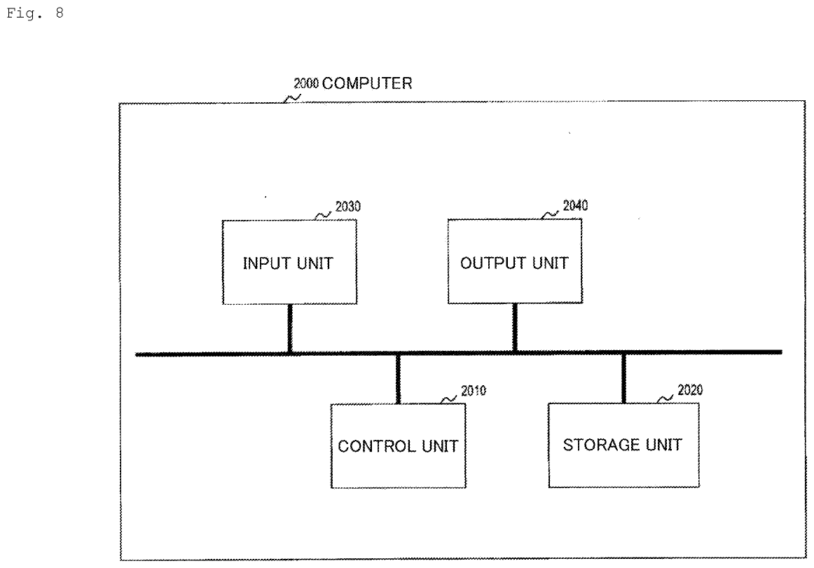

The above-described various types of processing can be performed by loading a program executing each step of the foregoing methods to a storage unit 2020 of a computer illustrated in FIG. 8 and operating a control unit 2010, an input unit 2030, and an output unit 2040.

A program describing the processing content can be recorded on a computer-readable recording medium. As the computer-readable recording medium, for example, any of a magnetic recording device, an optical disc, a magneto-optical recording medium, and a semiconductor memory may be used.

In addition, the distribution of this program is carried out by, for example, selling, transferring, or lending a portable recording medium such as a DVD or a CD-ROM on which the program is recorded. Further, the program may be distributed by storing the program in a storage device of a server computer and transmitting the program from the server computer to other computers via a network.

For example, a computer executing such a program first stores the program recorded on the portable recording medium or the program transmitted from the server computer temporarily in an own storage device. When processing is performed, the computer reads the program stored in the own recording medium and performs the processing in accordance with the read program. As another execution form of the program, a computer may directly read the program from a portable recording medium and execute processing in accordance with the program. Further, whenever the program is transmitted from the server computer to the computer, the processing may be performed in order in accordance with the received program. The above-described processing may be performed by a so-called application service provider (ASP) type service that realizes a processing function in accordance with only an execution instruction and result acquisition without transmitting the program from the server computer to the computer. Note that the program in the present mode includes information that is equivalent to a program and that is to be used for processing by an electronic computer (data that is not a direct instruction to the computer but has the property of defining the processing of the computer).

In this aspect, the device is configured by executing a predetermined program on a computer, but at least a part of the processing content may be implemented by hardware.

1. A detection method, the method comprising:
acquiring a target sound for detecting an event; and
detecting a desired event included in the acquired sound, wherein
even when any one of a distance and a direction of a sound source of the event, which are based on a position where the target sound is collected, and an occurrence time of the event changes, the events are detected as the same event.

2. The detection method according to claim 1, wherein constraints on rotational symmetry with respect to the acquired sound are imposed during detection of the desired event.

3. A detection method for detecting a desired event included in an acoustic signal, wherein
a detection model includes a deep neural network,
the method comprises:
a bilinear operation step of obtaining Z^{i+1,f,t}_{L,j} by
$${z}_{L , j}^{i + 1 , f , t} = {\sum }_{{L}_{1} , {L}_{2} : - \vert {L}_{1} - {L}_{2} \vert \leq L \leq {L}_{1} + {L}_{2}} {\sum }_{{j}_{1} = 1}^{{τ}_{i} , {L}_{1}} {\sum }_{{j}_{2} = 1}^{{τ}_{i} , {L}_{2}} {a}_{j , {j}_{1} , {j}_{2}}^{L , {L}_{1} , {L}_{2}} \frac{E}{\sqrt{‖ E ‖}} and \qquad [ Math . 92 ]$$
$$E = {C}^{L , {L}_{1} , {L}_{2}} ( {z}_{{L}_{1} , {j}_{1}}^{i , f , t} ⊗ {z}_{{L}_{2} , {j}_{2}}^{i , f , t} ) \qquad [ Math . 93 ]$$
using an output value Z^{i,f,t}_{L,j} of a previous layer, while a^{L,L_1,L_2}_{j,j_1,j_2} is defined as a weight of a linear sum and C^{L,L_1,L_2} is defined as a constant matrix; and
a time-frequency convolution step of performing time-frequency convolution to obtain Z^{i+1,f,t}_{L,j} by
$${z}_{L , j}^{i + 1 , f , t} = {\sum }_{{f}^{′} = 1}^{{K}_{i}} {{\sum }_{{t}^{′} = 1}}^{{L}_{i}} {\sum }_{{j}^{′} = 1}^{{τ}_{i} , L} {a}_{L , j , {j}^{′}}^{i , {f}^{′} , {t}^{′}} {z}_{L , {j}^{′}}^{i , f + {f}^{′} - 1 , t + {t}^{′} - 1} \qquad [ Math . 94 ]$$
using an output value Z^{i,f,t}_{L,j} of a previous layer, while a^{i,f,t}_{L,j,j′} is defined as a filter for each channel of complex variables.

4. A detection device, comprising:
an acquisition circuitry that acquires a target sound for detecting an event; and
a detection circuitry that detects a desired event included in the acquired sound, wherein
the detected desired event stays the same even when a distance, a direction of a sound source, and an occurrence time of the event change, wherein detected distance and the direction of the sound source are based on a position where the target sound is collected.

5. A detection device that detects a desired event included in an acoustic signal, wherein
a detection model includes a deep neural network,
the device comprises:
a bilinear operation unit that obtains Z^{i+1,f,t}_{L,j}
$${z}_{L , j}^{i + 1 , f , t} = {\sum }_{{L}_{1} , {L}_{2} : - \vert {L}_{1} - {L}_{2} \vert \leq L \leq {L}_{1} + {L}_{2}} {\sum }_{{j}_{1} = 1}^{{τ}_{i} , {L}_{1}} {\sum }_{{j}_{2} = 1}^{{τ}_{i} , {L}_{2}} {a}_{j , {j}_{1} , {j}_{2}}^{L , {L}_{1} , {L}_{2}} \frac{E}{\sqrt{‖ E ‖}} and \qquad [ Math . 95 ]$$
$$E = {C}^{L , {L}_{1} , {L}_{2}} ( {z}_{{L}_{1} , {j}_{1}}^{i , f , t} ⊗ {z}_{{L}_{2} , {j}_{2}}^{i , f , t} ) \qquad [ Math . 96 ]$$
using an output value Z^{i,f,t}_{L,j} of a previous layer, while a^{L,L_1,L_2}_{j,j_1,j_2} is defined as a weight of a linear sum and C^{L,L_1,L_2} is defined as a constant matrix; and
a time-frequency convolution unit that performs time-frequency convolution to obtain Z^{i+1,f,t}_{L,j} by
$${z}_{L , j}^{i + 1 , f , t} = {\sum }_{{f}^{′} = 1}^{{K}_{i}} {{\sum }_{{t}^{′} = 1}}^{{L}_{i}} {\sum }_{{j}^{′} = 1}^{{τ}_{i} , L} {a}_{L , j , {j}^{′}}^{i , {f}^{′} , {t}^{′}} {z}_{L , {j}^{′}}^{i , f + {f}^{′} - 1 , t + {t}^{′} - 1} \qquad [ Math . 97 ]$$
using an output value Z^{i,f,t}_{L,j} of a previous layer, while a^{i,f,t}_{L,j,j′} is defined as a filter for each channel of complex variables.

6. A computer-readable non-transitory recording medium storing computer-executable program instructions, for detecting sound events, that when executed by a processor cause a computer system to execute the detection method of claim 1.

7. The computer-readable non-transitory recording medium storing computer-executable program instructions, for detecting sound events, that when executed by a processor cause a computer system to execute the detection method of claim 2.

8. The computer-readable non-transitory recording medium storing computer-executable program instructions, for detecting sound events, that when executed by a processor cause a computer system to execute the detection method of claim 3.
